(19) United States
(12) Patent Application Publication
(10) Pub. No.: US 2010/0091082 A1
(43) Pub. Date: Apr. 15, 2010

(54) OPTICAL BEAM SCANNING APPARATUS AND IMAGE FORMING APPARATUS

(75) Inventor: Takashi SHIRAISHI, Kanagawa-Ken (JP)

Correspondence Address: PATTERSON & SHERIDAN, L.L.P., 3040 POST OAK BOULEVARD, SUITE 1500, HOUSTON, TX, 77056, US

(73) Assignees: KABUSHIKI KAISHA TOSHIBA, Tokyo (JP); TOSHIBA TEC KABUSHIKI KAISHA, Tokyo (JP)

(21) Appl. No.: 12/576,173

(22) Filed: Oct. 8, 2009

Related U.S. Application Data
(60) Provisional application No. 61/104,191, filed on Oct. 9, 2008.

(51) Int. Cl. B41J 2/435

(52) U.S. Cl. 347/243; 347/260; 347/259

(57) ABSTRACT

An optical beam scanning apparatus according to the present invention includes: a light source; a pre-deflection optical system; a light deflecting device; a post-deflection optical system configured to include at least one or plural second optical elements, which act on light beams of all color components, and plural third optical elements, which respectively act on the light beam of each of the color components, and focus the light beams scanned by the light deflecting device on the scanning object; and a position adjusting mechanism configured to adjust the positions of the third optical elements according to incident directions of the light beams made incident on the third optical elements. Consequently, according to the present invention, it is possible to suitably adjust optical elements included in a post-deflection optical system in which individual focusing lenses are provided for respective color components.

### CROSS-REFERENCE TO RELATED APPLICATIONS

This application is based upon and claims the benefit of priority from: U.S. provisional application 61/104,191, filed on Oct. 9, 2008, the entire contents of which are incorporated herein by reference.

### TECHNICAL FIELD

The present invention relates to an optical beam scanning apparatus and an image forming apparatus, and, more particularly to an optical beam scanning apparatus and an image forming apparatus that can separate one or plural light beams, which are emitted from one or plural light sources, for each of color components in a sub-scanning direction with a deflection surface of a deflecting device and focus the light beams with a post-deflection optical system to form plural scanning lines, or can deflect plural light beams which are made incident on the deflecting device through plural optical paths by the deflecting device and focus the light beams with the post-deflection optical system to form plural scanning lines, plural optical paths being different from each other.

### BACKGROUND

A laser printer, a digital copying machine, and a laser facsimile are examples of an image forming apparatus of an electrophotographic system. The image forming apparatus of the electrophotographic system includes an optical beam scanning apparatus that irradiates a laser beam (a light beam) on the surface of a photoconductive drum and scans the laser beam to thereby form an electrostatic latent image on the photoconductive drum.

Recently, a tandem color machine is proposed besides a monochrome machine including a scanning optical system employing a single light source. For the tandem color machine, for the purpose of increasing speed of scanning on the surfaces of photoconductive drums, there is proposed a method of providing plural light sources (laser diodes) in one laser unit to increase the number of laser beams scanned in one time (a multibeam method). In the multibeam method, plural beams for each of color components (e.g., yellow, magenta, cyan, and black) emitted from the respective light sources are processed in a pre-deflection optical system and converted into one beam to be made incident on a polygon mirror. The beam deflected by the polygon mirror is separated into a beam of each of the color components and irradiated on a photoconductive drum for each of the color components after passing through an fθ lens included in a post-deflection optical system.

An image forming apparatus for the tandem color machine in the past adjusts a focus position in a sub-scanning direction using a cylinder lens of the pre-deflection optical system, the cylinder lens acting on light beams for all color components. However, in adjusting the focus position in the sub-scanning direction using the cylinder lens of the pre-deflection optical system, the cylinder lens acting on light beams for all color components, the image forming apparatus can only adjust a focus position in the sub-scanning direction of one color component and cannot adjust focus position in the sub-scanning direction of all the color components.

Even if an optical characteristic in the scanning optical system can be nearly perfectly set, scanning lines on the photoconductive drum for each of the color components could tilt with respect to the photoconductive drum depending on a way of attaching the photoconductive drum. The tilt of the scanning lines could be different for each of the color components. Therefore, in the image forming apparatus for the tandem color machine in the past, it is difficult to appropriately adjust the optical characteristic of the scanning optical system in which an individual focusing lens is provided for each of the color components.

### SUMMARY

The present invention has been devised in view of such circumstances and it is an object of the present invention to provide an optical beam scanning apparatus and an image forming apparatus that can suitably adjust optical elements included in a scanning optical system in which an individual focusing lens is provided for each of color components.

In order to solve the problems, an optical beam scanning apparatus according to an aspect of the present invention includes: one or plural light sources configured to emit one or plural light beams; a pre-deflection optical system configured to include a first optical element having positive optical power in a sub-scanning direction, which acts on all the light beam or all the light beams emitted from the one or plural light sources, and form the light beam or the light beams emitted from the one or plural light sources to focus the light beam or the light beams as a line image in a direction corresponding to a main scanning direction; a light deflecting device configured to scan the light beam or the light beams focused by the pre-deflection optical system in the main scanning direction with respect to a scanning object; a post-deflection optical system, including at least one or plural second optical elements which act on light beam or light beams of all color components and plural third optical elements which respectively act on the light beam of each of the color components, configured to focus the light beam or the light beams scanned by the light deflecting device on the scanning object; and a position adjusting mechanism configured to adjust positions of the third optical elements according to incident directions of the light beam or the light beams made incident on the third optical elements.

In order to solve the problems, an optical beam scanning apparatus according to an aspect of the present invention includes: one or plural light source configured to emit one or plural light beams; a pre-deflection optical system configured to include a first optical element having positive optical power in a sub-scanning direction, which acts on all the light beam or all the light beams emitted from the one or plural light sources, and form the light beam or the light beams emitted from the one or plural light sources to focus the light beam or the light beams as a line image in a direction corresponding to a main scanning direction; a light deflecting device configured to scan the light beam or the light beams focused by the pre-deflection optical system in the main scanning direction with respect to a scanning object; a post-deflection optical system, including at least one or plural second optical elements which act on light beam or light beams of all color components and plural third optical elements that respectively act on the light beam of each of the color components and are molded by the same cavity or cavities in which at least two or more different cavities are combined, configured to focus the light beam or the light beams scanned by the light deflecting device on the scanning object; and a position adjusting mechanism configured to adjust positions of the third optical elements along the sub-scanning direction.

In order to solve the problems, an image forming apparatus according to still another aspect of the present invention is an image forming apparatus including an optical beam scanning apparatus, the optical beam scanning apparatus including: one or plural light source configured to emit one or plural light beams; a pre-deflection optical system configured to include a first optical element having positive optical power in a sub-scanning direction, which acts on all the light beam or all the light beams emitted from the one or plural light sources, and form the light beam or the light beams emitted from the one or plural light sources to focus the light beam or the light beams as a line image in a direction corresponding to a main scanning direction; a light deflecting device configured to scan the light beam or the light beams focused by the pre-deflection optical system in the main scanning direction with respect to a scanning object; a post-deflection optical system, including at least one or plural second optical elements which act on light beam or light beams of all color components and plural third optical elements which respectively act on the light beam of each of the color components, configured to focus the light beam or the light beams scanned by the light deflecting device on the scanning object; and a position adjusting mechanism configured to adjust positions of the third optical elements according to incident directions of the light beam or the light beams made incident on the third optical elements.

In order to solve the problems, an image forming apparatus according to still another aspect of the present invention is an image forming apparatus including an optical beam scanning apparatus, the optical beam scanning apparatus including: one or plural light source configured to emit one or plural light beams; a pre-deflection optical system configured to include a first optical element having positive optical power in a sub-scanning direction, which acts on all the light beam or all the light beams emitted from the one or plural light sources, and form the light beam or the light beams emitted from the one or plural light sources to focus the light beam or the light beams as a line image in a direction corresponding to a main scanning direction; a light deflecting device configured to scan the light beam or the light beams focused by the pre-deflection optical system in the main scanning direction with respect to a scanning object; a post-deflection optical system, including at least one or plural second optical elements which act on light beam or light beams of all color components and plural third optical elements that respectively act on the light beam of each of the color components and are molded by the same cavity or cavities in which at least two or more different cavities are combined, configured to focus the light beam or the light beams scanned by the light deflecting device on the scanning object; and a position adjusting mechanism configured to adjust positions of the third optical elements along the sub-scanning direction.

In order to solve the problems, an optical beam scanning apparatus according to still another aspect of the present invention includes: one or plural light source configured to emit one or plural light beams; a pre-deflection optical system configured to include a first optical element having positive optical power in a sub-scanning direction, which acts on all the light beam or all the light beams emitted from the one or plural light sources, and form the light beam or the light beams emitted from the one or plural light sources to focus the light beam or the light beams as a line image in a direction corresponding to a main scanning direction; a light deflecting device configured to scan the light beam or the light beams focused by the pre-deflection optical system in the main scanning direction with respect to a scanning object; a post-deflection optical system, including at least one or plural second optical elements which act on light beam or light beams of all color components and plural third optical elements that respectively act on the light beam of each of the color components and are molded by the same cavity or cavities in which at least two or more different cavities are combined, configured to focus the light beam or the light beams scanned by the light deflecting device on the scanning object, the post-deflection optical system having a same number of folding mirrors between the respective third optical elements and the scanning object or having no folding mirror between the third optical elements and the scanning object.

### DESCRIPTION OF THE DRAWINGS

In the accompanying drawings:

FIG. 1 is a side view of a configuration of an image forming apparatus incorporating an optical beam scanning apparatus to which the present invention is applied;

FIG. 2A is an expanded view of folding by a folding mirror provided in the optical beam scanning apparatus;

FIG. 2B is a diagram of the folding by the folding mirror shown in FIG. 2A viewed from an arrow P direction;

FIG. 2C is a diagram of the folding by the folding mirror shown in FIG. 2A viewed from an arrow Q direction;

FIG. 2D is a diagram of the folding by the folding mirror shown in FIG. 2A viewed from an arrow R direction;

FIG. 3 is a diagram of optical paths for respectively guiding beams to photoconductive drums using two folding mirrors including a folding mirror 40 and a folding mirror 41 for four colors Y, M, C, and K, the folding mirror 40 being provided on an upstream side of the individual lens 37-2 in optical path, and the folding mirror 41 being provided on downstream side of the individual lens 37-2 in optical path;

FIG. 4 is a diagram of optical paths for respectively guiding beams to the photoconductive drums using two folding mirrors including a folding mirror 40 and a folding mirror 41 for the four colors Y, M, C, and K, the folding mirror 40 and the folding mirror 41 being provided on an upstream side of the individual lens 37-2 in optical path;

FIG. 5A is a side view of a position adjusting mechanism provided on one end side of an individual lens;

FIG. 5B is a side view of a position adjusting mechanism provided on the other end side of the individual lens;

FIG. 5C is a sectional view of the individual lens held by a frame sheet metal;

FIG. 5D is a plan view of the individual lens held by the frame sheet metal;

FIG. 6A is a side view of a position adjusting mechanism provided on one end side of an individual lens;

FIG. 6B is a side view of a position adjusting mechanism provided on the other end side of the individual lens;

FIG. 7A is a side view of a position adjusting mechanism provided on one end side of a folding mirror;

FIG. 7B is a side view of a position adjusting mechanism provided on the other end side of the folding mirror;

FIGS. 8A to 8C are diagrams showing expansion of folding by a folding mirror provided in the optical beam scanning apparatus; and

FIGS. 9A to 9F are a plan view, a sectional view, and side view of a polygon mirror main body of a deflecting device used in a scanning optical system of the optical beam scanning apparatus.

### DETAILED DESCRIPTION

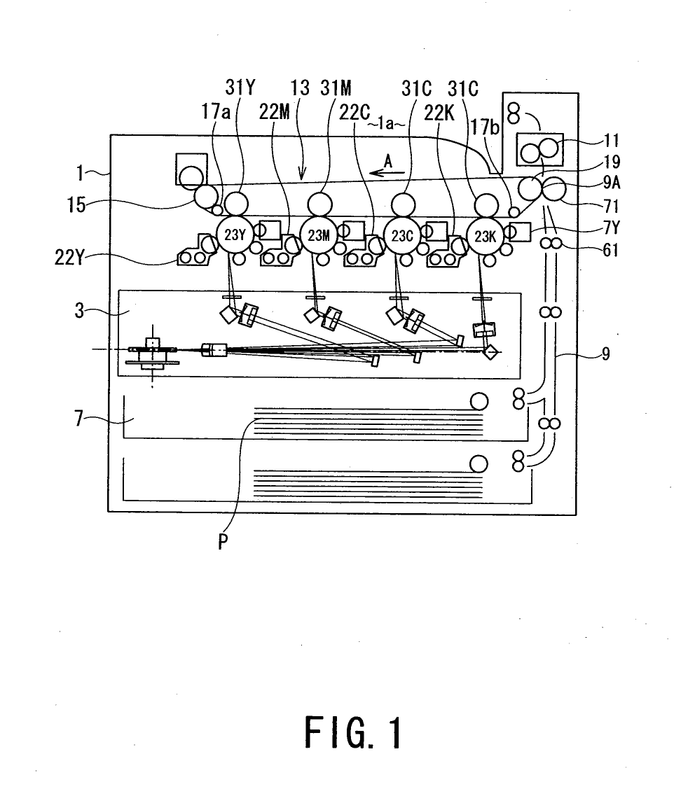

An embodiment of the present invention is explained below with reference to the accompanying drawings. FIG. 1 is a configuration of an image forming apparatus 1 incorporating an optical beam scanning apparatus (an exposing apparatus) 3 according to the embodiment. In the explanation of this embodiment, the image forming apparatus 1 is applied to a color printer apparatus. However, the image forming apparatus 1 is not limited to this application and can also be applied to various image output apparatuses such as a full-color copying apparatus, a facsimile apparatus, and a workstation apparatus.

The image forming apparatus 1 includes the optical beam scanning apparatus (the exposing apparatus) 3 that generates image light corresponding to an image signal and an image forming unit that transfers a toner image, which is visualized by a toner as a developer on the basis of the image light supplied by the optical beam scanning apparatus 3, onto a sheet P as a transfer medium used for an output called hardcopy or printout and outputs the toner image. The image forming apparatus 1 also includes a sheet storing unit 7 that stores an arbitrary number of sheets P having a predetermined size and can feed the sheets P one by one according to timing if the toner image is formed by the image forming unit. The sheet storing unit 7 feeds the sheet P every time the toner image is formed.

The image forming apparatus 1 includes, between the sheet storing unit 7 and the image forming unit, a conveying path 9 through which the sheet storing unit 7 guides the sheet P to the image forming unit. The conveying path 9 guides, through a transfer device 9A that transfers the toner image formed by the image forming unit onto the sheet P, the sheet P to a fixing device 11 that fixes the toner image, which is transferred on the sheet P, on the sheet P. As another function, the conveying path 9 guides the sheet P on which the toner image is fixed by the fixing device 11 to an image output and holding unit 1a also serving as a part of a cover that covers the image forming unit.

The image forming unit includes an intermediate transfer belt 13 obtained by forming an insulative film having predetermined thickness in an endless belt shape. Metal formed in a thin sheet shape and then protected by resin or the like on the surface thereof may be applied as the intermediate transfer belt 13. A driving roller 15, first and second tension rollers 17a and 17b, and a transfer roller 19 apply predetermined tension to the intermediate transfer belt 13. According to the rotation of the driving roller 15, an arbitrary position parallel to the axis of the driving roller 15 moves in an arrow A direction. In other words, the belt surface of the intermediate transfer belt 13 circulates in one direction at the speed of movement of the outer circumferential surface of the driving roller 15.

First to fourth image forming units 21Y, 21M, 21C, and 21K are arrayed at predetermined intervals in a section where the belt surface of the intermediate transfer belt 13 substantially flatly moves in a state in which the rollers (the driving roller 15, the first and second tension rollers 17a and 17b, and the transfer roller 19) apply the predetermined tension to the intermediate transfer belt 13.

The first to fourth image forming units 21Y, 21M, 21C, and 21K respectively include at least developing devices 22Y, 22M, 22C, and 22K in which toners of arbitrary colors Y (yellow), M (magenta), C (cyan), and K (black) are respectively stored and photoconductive drums 23Y, 23M, 23C, and 23K that respectively hold electrostatic latent images that the developing devices 22 (the developing devices 22Y, 22M, 22C, and 22K) should develop. Electrostatic latent images corresponding to images of the colors that should be respectively developed by the developing devices 22Y, 22M, 22C, and 22K provided in the image forming units 21 are formed by image light from the optical beam scanning apparatus 3 on the surfaces (outer circumferential surfaces) of the photoconductive drums 23Y, 23M, 23C, and 23K included in the image forming units 21. Consequently, the toner is selectively fed by any one of the developing devices 22Y, 22M, 22C, and 22K corresponding thereto. As a result, toner images of the colors decided in advance are respectively formed on the photoconductive drums 23Y, 23M, 23C, and 23K.

The first to fourth image forming units 21Y, 21M, 21C, and 21K respectively include, in positions opposed to the photoconductive drums 23Y, 23M, 23C, and 23K via the intermediate transfer belt 13, transfer rollers 31Y, 31M, 31C, and 31K for transferring the toner images held by the photoconductive drums 23 onto the intermediate transfer belt 13. The transfer rollers 31Y, 31M, 31C, and 31K are provided on the backside of the intermediate transfer belt 13.

The image forming apparatus 1 in which the developing devices 22 (22Y, 22M, 22C, and 22K), the photoconductive drums 23 (23Y, 23M, 23C, and 23K), and the transfer rollers 31 (31Y, 31M, 31C, and 31K) are arrayed as explained above includes an image-signal supply unit.

The image-signal supply unit supplies image signals for the respective color components to the optical beam scanning apparatus 3. The optical beam scanning apparatus 3 generates image lights corresponding to the image signals supplied by the image-signal supply unit and irradiates the generated image lights on the surfaces of the photoconductive drums 23 (23Y, 23M, 23C, and 23K) integral with the developing devices 22 (22Y, 22M, 22C, and 22K) that store the toners of the color components corresponding to the image lights. When the image lights are irradiated, the image forming units 21 form electrostatic latent images at predetermined timing such that the toner images sequentially transferred onto the intermediate transfer belt 13 are superimposed one on top of another on the intermediate transfer belt 13 and develop (visualize) the electrostatic latent images with the developing devices 22 corresponding to the image forming units 21.

The toner images formed on the photoconductive drums 23 of the image forming units 21 are transferred onto the intermediate transfer belt 13 by the transfer rollers 31 (31Y, 31M, 31C, and 31K) as primary transfer devices respectively corresponding to the photoconductive drums 23 (23Y, 23M, 23C, and 23K). The toner images of Y, M, C, and K are sequentially laminated on the intermediate transfer belt 13 that moves at predetermined speed. In FIG. 1, roller members are used as the transfer rollers 31 as the primary transfer devices. However, the transfer rollers 31 are not limited to the roller members and may be voltage generating devices such as scorotrons.

The image forming apparatus 1 includes a secondary transfer roller 71 as a secondary transfer device. The secondary transfer roller 71 comes into contact with the intermediate transfer belt 13 with predetermined pressure in a transfer position 9A of the conveying path 9. The secondary transfer roller 71 as the secondary transfer device transfers a full-color toner image superimposed on the intermediate transfer belt 13 onto the sheet P guided to the transfer position 9A of the conveying path 9.

The image forming apparatus 1 includes a registration roller 61 that temporarily stops the sheet P, which is guided from the sheet storing unit 7 to the transfer position 9A, in a predetermined position in the conveying path 9 between the sheet storing unit 7 and the transfer position 9A. The registration roller 61 includes two rollers. At least one roller rotates in a predetermined direction. The other roller is pressed against one roller with predetermined pressure via a not-shown press-contact mechanism.

The sheet P is guided through the conveying path 9 from the sheet storing unit 7 to the transfer position 9A and temporarily stopped by the registration roller 61. This makes it possible to correct a tilt (a tilt of the sheet P with respect to a conveying direction) that could occur during the conveyance through the conveying path 9 from the sheet storing unit 7 to the transfer position 9A.

Timing when a toner image carried to the transfer position 9A according to the movement of the belt surface of the intermediate transfer belt 13 reaches the transfer position 9A and timing when the sheet P reaches the transfer position 9A are set according to timing when the registration roller 61 is rotated again. This makes it possible to arbitrarily set the position of the toner image with respect to the sheet P and manage the position of the toner image with respect to the sheet P.

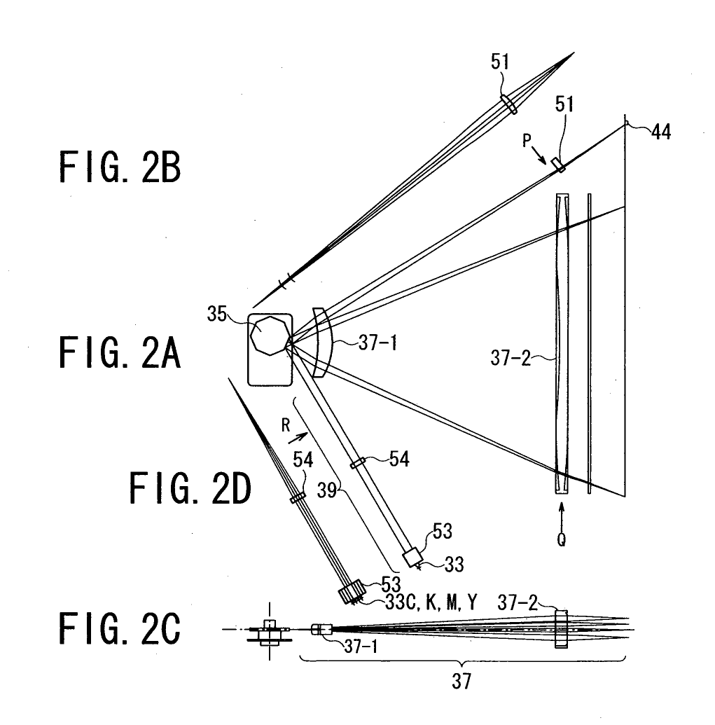

FIG. 2A is an expanded view of folding by a folding mirror provided in the optical beam scanning apparatus 3. FIG. 2B is a diagram of the folding by the folding mirror shown in FIG. 2A viewed from an arrow P direction. FIG. 2C is a diagram of the folding by the folding mirror shown in FIG. 2A viewed from an arrow Q direction. FIG. 2D is a diagram of the folding by the folding mirror shown in FIG. 2A viewed from an arrow R direction. As shown in FIGS. 2A to 2D, the optical beam scanning apparatus 3 includes at least light sources (semiconductor laser elements) 33 (33C, 33K, 33M, and 33Y) that output image lights (exposure lights), collimator lenses 53 (53Y, 53M, 53C, and 53K) that convert the image lights from the light sources 33 (33C, 33K, 33M, and 33Y) into substantially parallel beams, a cylinder lens 54 as an optical element having positive power only in the sub-scanning direction that condenses beams from the collimator lenses 53 and principal beams near a reflection surface of a deflecting device 35, the deflecting device 35 that scans image lights from the cylinder lens 54 in a raster direction in outputting (hard-copying or printing out) the sheet P, a post-deflection optical system (an image forming optical system) 37 that condenses the image lights raster-deflected (scanned) by the deflecting device 35 on the photoconductive drums 23 (23Y, 23M, 23C, and 23K) of the first to fourth image forming unit 21 under a predetermined condition irrespective of a deflection angle, and a pre-deflection optical system (an exposure light shaping optical system) 39 that guides the image lights from the light sources 33 to the deflecting device 35 under a predetermined condition. The pre-deflection optical system 39 includes at least the collimator lenses 53 and a cylinder lens 54. Finite lenses may be used instead of the collimator lenses 53. FIG. 2A shows the collimator lenses 53 which is formed by superimposing collimator lenses for the respective color components. An optical system including the pre-deflection optical system 39 and the post-deflection optical system 37 that guides the image lights from the light sources 33 to the photoconductive drums 23 is defined as “scanning optical system”.

A direction in which laser beams are deflected (scanned) by the deflecting device 35 (a rotation axis direction of the photoconductive drums 23) is defined as “main scanning direction”. A direction perpendicular to the optical axis of the optical system and the main scanning direction is defined as “sub-scanning direction”. Therefore, the sub-scanning direction is a drum rotating direction on the photoconductive drums 23.

The deflective device 35 includes a polygonal mirror main body (so-called polygon mirror), for example, eight plane reflection surfaces (plane reflection mirrors) of which are arranged in a regular polygonal shape, and a motor that rotates the polygonal mirror main body in the main scanning direction at predetermined speed. The polygonal mirror main body is a rotatable reflection element and is fixed to a shaft of the motor. The number of reflection surfaces provided in the polygonal mirror main body as the reflection element and the number of revolutions of the polygonal mirror main body are specified according to output requirements (i.e., resolution, output speed, and other requirements required of the image forming apparatus 1).

The post-deflection optical system 37 includes at least a shared lens 37-1 as focusing lenses used for all scanning lines for forming electrostatic latent images of the respective colors guided to the photoconductive drums 23 and individual lenses 37-2 as focusing lenses corresponding to the respective scanning lines for forming the electrostatic latent images of the respective colors guided to the photoconductive drums 23. The shared lens 37-1 gives different light condensing properties to the image lights raster-scanned by the deflecting device 35 in association with positions in a longitudinal direction of the photoconductive drums 23Y, 23M, 23C, and 23K (i.e., positions on the photoconductive drums 23 depending on a swing angle (a deflection angle) of the image lights caused when the image lights are raster-deflected in the main scanning direction orthogonal to the direction in which the sheet P is conveyed (the direction in which the photoconductive drums 23 are rotated)). The shared lens 37-1 has a slender shape extending in the longitudinal direction of the photoconductive drums 23. The optical beam scanning apparatus 3 may include plural shared lenses 37-1.

The post-deflection optical system 37 includes, besides the shared lens 37-1 and the individual lenses 37-2, various optical elements (e.g., a mirror and a filter) for guiding the image lights raster-scanned by the deflecting device 35 to the photoconductive drums 23Y, 23M, 23C, and 23K of the first to fourth image forming units 21. According to optimization of types and shapes of the optical elements and a combination of arrays of the optical elements, the shared lens 37-1 and the individual lenses 37-2 may be replaced with mirrors having curved surfaces having similar function to the lenses. The replacement with the mirrors may be applied to both the shared lens 37-1 and the individual lenses 37-2 or may be applied to any one of the shared lens 37-1 and the individual lenses 37-2.

A focus position (a focus position on the front side in the sub-scanning direction) of the shared lens 37-1 is set further on an upstream side (on a side on which the rotation center axis of the polygonal mirror main body is present and may be beyond the rotation center axis) than the reflection surfaces (the polygon mirror surfaces) of the deflecting device 35 such that an inter-beam distance of beams for generating electrostatic latent images of the respective colors emitted from the shared lens 37-1 increases toward downstream of optical paths. The shared lens 37-1 has larger power in the sub-scanning direction than in the main scanning direction. Power in the sub-scanning direction of the shared lens 37-1 is large on both end sides in the main scanning direction of the shared lens 37-1 compared with the center in the main scanning direction of the shared lens 37-1. Consequently, the shared lens 37-1 can relax bends of tracks of beams made incident on the individual lenses 37-2 from the shared lens 37-1 (scanning line bends).

The pre-deflection optical system 39 shapes the image lights from the light sources 33 to have a sectional beam shape satisfying a predetermined condition (to be condensed) when the image lights are raster-scanned by the deflecting device 35 and respectively condensed in predetermined positions in the longitudinal direction of the photoconductive drums 23Y, 23M, 23C, and 23K in the post-deflection optical system 37. The pre-deflection optical system 39 includes optical elements such as a condenser lens, a mirror, and an aperture.

Predetermined intervals (substantially equal intervals on the belt surface of the intermediate transfer belt 13) corresponding to positions where the respective image forming units 21 are arrayed are given to the image lights emitted from the optical beam scanning apparatus 3. Intervals of the image lights emitted from the optical beam scanning apparatus 3 are specified as, for example, an integer time of a circumference (a rotation pitch of the driving roller 15) calculated by adding up the diameter of the driving roller 15 and the thickness of the intermediate transfer belt 13. Therefore, even if there is eccentricity or the like in the driving roller 15, the same period is given when images are formed in the first to fourth image forming unit 21. This makes it possible to reduce the influence of eccentricity such as color drift.

The optical beam scanning apparatus 3 includes a horizontal synchronization sensor 44 for determining image writing (exposing) timing in the main scanning direction on the photoconductive drums 23. The optical beam scanning apparatus 3 further includes an optical element 51 that causes only a beam for black to light when beams (rays) pass through the horizontal synchronization sensor 44 and condenses the beams in the sub-scanning direction to thereby condense the beams on the horizontal synchronization sensor 44. In this embodiment, the optical element 51 is a plano-convex cylinder lens. Writing of images in the main scanning direction on the photoconductive drums 23 for Y, M, and C is started when time set in advance elapses after the beam for black passes through the horizontal synchronization sensor 44. Since all beams are scanned on the photoconductive drums 23 by using one reflection surface among the plural reflection surfaces of the deflecting device 35 when the deflecting device 35 scans beams of the four color components on the photoconductive drums 23 once, writing timing is controlled by the horizontal synchronization sensor 44 to fix relative time when beams of the color components pass a reference position in all the reflection surfaces of the deflecting device 35 when the optical beam scanning apparatus 3 scans the beams of the color components in the main scanning direction.

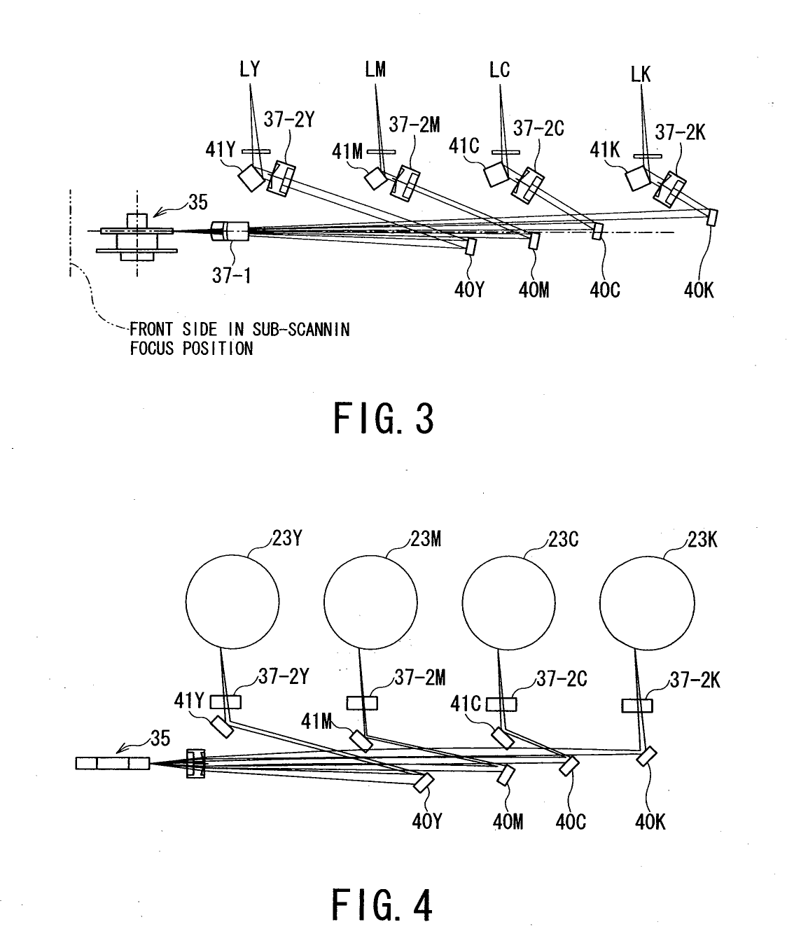

FIG. 3 is a diagram of optical paths for respectively guiding beams to photoconductive drums using two folding mirrors including a folding mirror 40 and a folding mirror 41 for four colors Y, M, C, and K, the folding mirror 40 being provided on an upstream side of the individual lens 37-2 in optical path, and the folding mirror 41 being provided on downstream side of the individual lens 37-2 in optical path. As explained above, the focus position (the focus position on the front side in the sub-scanning direction) of the shared lens 37-1 is set further on an upstream side (on a side on which the rotation center axis of the polygonal mirror main body is present and may be beyond the rotation center axis) than the reflection surfaces (the polygon mirror surfaces) of the deflecting device 35 such that an inter-beam distance of beams for generating electrostatic latent images of the respective colors emitted from the shared lens 37-1 increases toward downstream of the optical paths. Consequently, beams folded by a folding mirror which is provided further on the upstream side of the optical paths in the folding mirrors 40Y, 40M, 40C, and 40K that separate the beams raster-deflected by the deflecting device 35 for each of the color components have wide intervals in the same beam traveling direction position.

The four folding mirrors are arranged in order of the folding mirror 40Y, the folding mirror 40M, the folding mirror 40C, and the folding mirror 40K from the upstream side. A relation of intervals in the same position in a beam traveling direction is LY-LM>LM-LC>LK-LC.

The individual lenses 37-2 (37-2Y, 37-2M, 37-2C, and 37-2K) are respectively arranged between the two folding mirrors 40 and 41 in the optical paths of the beams folded by the two folding mirrors 40 and 41. The individual lenses 37-2 (37-2Y, 37-2M, 37-2C, and 37-2K) for the respective color components of the post-deflection optical system of the scanning optical system are molded by using the same cavity (molded article space).

In general, a die for molding the individual lenses 37-2 has plural cavities. For example, the die for molding the individual lenses 37-2 has four cavities. The die has a temperature distribution corresponding to a direction of flowing water that flows through a cooling pipe of the mold. Therefore, even if the plural cavities of the mold have the same shape, depending on the positions of the cavities molding of resin is affected by different influences based on the temperature distribution of the mold. Since the molding of resin is affected by different influences based on the temperature distribution of the mold, the molded individual lenses 37-2 have different amounts of warp depending on the positions of the cavities. Bends of the scanning lines are determined by the amount of warp of the individual lenses 37-2. Therefore, in the case of this embodiment, in order to set bends of the scanning lines for the respective color components to the same degree, every individual lens 37-2 in the four individual lenses 37-2 (37-2Y, 37-2M, 37-20, and 37-2K) corresponding to the four color components is an individual lens 37-2 which is molded by the same cavity among the plural cavities of the mold. Since the four individual lenses 37-2 are molded by the same cavity, the image forming apparatus 1 can suppress deviation in color superimposition. If the difference between the amount of warp in plural individual lenses 37-2 molded by at least two different cavities is less than a threshold value, this embodiment may use a combination of plural individual lenses 37-2 molded by at least two different cavities as the four individual lenses 37-2, instead of using a combination of only the individual lens 37-2 molded by the same cavity.

The folding mirrors, which are arranged further on the downstream side of the optical path than the individual lenses 37-2, reverse the bend of the scanning lines. The bend of the scanning lines is due to the warp of the individual lens 37-2. Therefore, in order to set bending directions of the scanning lines the same among the color components, the numbers of folding mirrors between the individual lenses 37-2 and the photoconductive drums 23 of the scanning optical system need to be the same among the color components. In the case of FIG. 3, the scanning optical system includes, for each of the color components, the one folding mirror between the individual lenses 37-2 and the photoconductive drums 23. It goes without saying that the optical beam scanning apparatus 3 does not have to include folding mirrors between the individual lenses 37-2 and the photoconductive drums 23. FIG. 4 is a diagram of optical paths for respectively guiding beams to the photoconductive drums using two folding mirrors including a folding mirror 40 and a folding mirror 41 for the four colors Y, M, C, and K, the folding mirror 40 and the folding mirror 41 being provided on an upstream side of the individual lens 37-2 in optical path. In the case of FIG. 4, the optical beam scanning apparatus 3 does not include folding mirrors between the individual lenses 37-2 and the photoconductive drums 23. The individual lenses 37-2 are arranged on the most downstream side of the scanning optical system.

In the case of FIG. 3, beams LK and LY are beams on both sides in the sub-scanning direction. The beam LY at one end in the sub-scanning direction is reflected by the folding mirror 40Y on the most upstream side and the beam LK at the other end in the sub-scanning direction is reflected by the folding mirror 40K on the most downstream side.

When defocus in the main scanning direction occurs concerning the optical elements included in the scanning optical system because of an error during manufacturing of a housing, the image forming apparatus 1 according to this embodiment adjusts a focus position in the main scanning direction by adjusting the position of the collimator lenses 53 or the light sources 33. Specifically, the image forming apparatus 1 according to this embodiment adjusts the focus position in the main scanning direction by moving the collimator lenses 53 or the light sources 33 in the optical axis direction. On the other hand, when defocus in the sub-scanning direction occurs concerning the optical elements included in the scanning optical system because of an error during manufacturing of the housing, the image forming apparatus 1 according to this embodiment adjusts a focus position in the sub-scanning direction of the beam LK (a beam for black) using the cylinder lens 54 of the pre-deflection optical system 39, which is the optical element having positive power only in the sub-scanning direction. The image forming apparatus 1 adjusts focus positions in the sub-scanning direction of the beam LY (a beam for yellow), the beam LM (a beam for magenta), and the beam LC (a beam for cyan) using a position adjusting mechanism 69 that adjusts the positions of the individual lenses 37-2. Specifically, the image forming apparatus 1 according to this embodiment adjusts the focus position in the sub-scanning direction of the beam LK by moving the cylinder lens 54 of the pre-deflection optical system 39, which is the optical element having positive power only in the sub-scanning direction, in an optical axis direction. The image forming apparatus 1 adjusts the focus positions in the sub-scanning direction of the beams LY, LM, and LC by moving the individual lenses 37-2 in a direction parallel to an incident optical path (i.e., the optical axis direction) using position adjusting mechanisms 69 that adjust the positions of the individual lenses 37-2. Consequently, the image forming apparatus 1 according to this embodiment can suitably adjust the optical elements included in the scanning optical system in which the individual focusing lenses are provided for the respective color components. The position adjusting mechanisms 69 are explained below. The optical beam scanning apparatus 3 includes three position adjusting mechanisms 69 that respectively adjust the positions of the individual lenses 37-2 other than the individual lens 37-2K in the optical path of the beam LK in which the focus position in the sub-scanning direction of the beam LK is adjusted by moving the cylinder lens 54.

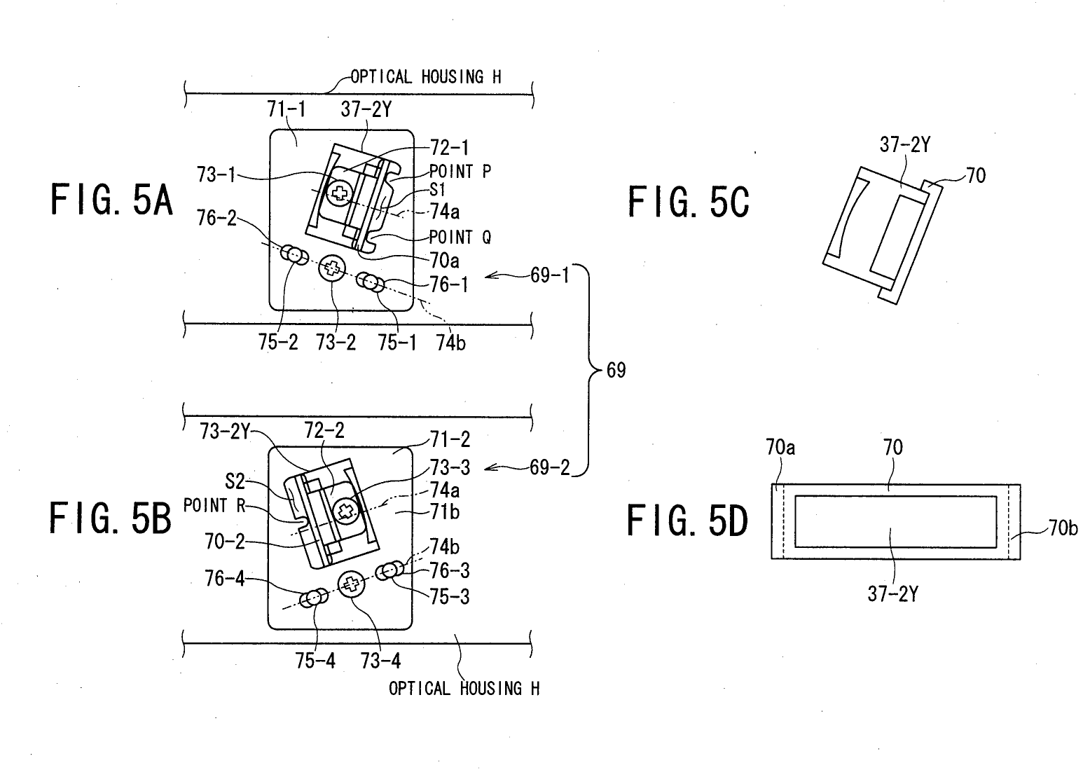

FIGS. 5A to 5D are diagrams of the position adjusting mechanism 69 for adjusting, for example, the position of the individual lens 37-2Y among the individual lenses 37-2Y, 37-2M, and 37-2C. FIG. 5A is a side view of a position adjusting mechanism 69-1 provided on one end side of the individual lens 37-2Y. FIG. 5B is a side view of a position adjusting mechanism 69-2 provide on the other side end of the individual lens 37-2. The pair of the position adjusting mechanism 69-1 and the position adjusting mechanism 69-2 forms the position adjusting mechanism 69. An alternate long and two short dashes line 74a shown in FIG. 5A indicates an incident optical path for the beam LY. An optical housing H of the optical beam scanning apparatus 3 has, on one side on the outer side of the optical housing H of the optical beam scanning apparatus 3, two projections 75-1 and 75-2 used for adjusting the position of the individual lens 37-2Y. The two projections 75-1 and 75-2 are inserted into elongated holes 76-1 and 76-2 of a sheet metal 71-1 provided on the outer side of the optical housing H. The two projections 75-1 and 75-2 of the optical housing H of the optical beam scanning apparatus 3 are provided on an alternate long and two short dashes line 74b parallel to the alternate long and two short dashes line 74a. Consequently, in the position adjusting mechanism 69-1 shown in FIG. 5A, the sheet metal 71-1 can move in parallel to the alternate long and two short dashes line 74a. The sheet metal 71-1 has an opening S1 on a right portion of the sheet metal 71-1.

FIG. 5C is a sectional view of the individual lens 37-2 held by a frame sheet metal 70. FIG. 5D is a plan view of the individual lens 37-2 held by the frame sheet metal 70. The frame sheet metal 70 is a sheet metal of a frame shape having an opening in the center. The frame sheet metal 70 is bonded or screwed around the individual lens 37-2Y and holds the individual lens 37-2Y. The frame sheet metal 70 includes ear portions 70a and 70b at both the ends. The ear portion 70a of the sheet metal 70 is inserted into the opening S1 of the sheet metal 71-1. The optical housing H has an opening of a required size such that the frame sheet metal 70 can move after the ear portion 70a of the frame sheet metal 70 is inserted in the opening S1 of the sheet metal 71-1. A leaf spring 72-1 is screwed to the sheet metal 71-1 by a screw 73-1. As shown in FIG. 5A, the leaf spring 72-1 comes into contact with the ear portion 70a of the sheet metal 70. The individual lens 37-2Y is pressed against a projection P and a projection Q of the sheet metal 71-1 via the leaf spring 72-1 and fixed to the sheet metal 71-1. Therefore, when the sheet metal 71-1 is moved in parallel to the alternate long and two short dashes line 74a by a predetermined distance, the individual lens 37-2Y fixed to the sheet metal 71-1 also moves in a direction parallel to the alternate long and two short dashes line 74a by a moving distance same as a moving distance of the sheet metal 71-1 according to the movement of the sheet metal 71-1.

On the other hand, as shown in FIG. 5B, the optical housing H of the optical beam scanning apparatus 3 has, on the other surface on the outer side of the optical housing H of the optical beam scanning apparatus 3, two projections 75-3 and 75-4 used for adjusting the position of the individual lens 37-2Y. The two projections 75-3 and 75-4 are inserted into elongated holes 76-3 and 76-4 of a sheet metal 71-2 provided on the outer side of the optical housing H. The two projections 75-3 and 75-4 of the optical housing H of the optical beam scanning apparatus 3 are provided on the alternate long and two short dashes line 74b parallel to the alternate long and two short dashes line 74a. Consequently, in the position adjusting mechanism 69-2 shown in FIG. 5B, the sheet metal 71-2 can move in, parallel to the alternate long and two short dashes line 74a. The sheet meal 71-2 has an opening S2 in a right portion of the sheet metal 71-2.

The ear portion 70b of the sheet metal 70 is inserted into the opening S2 of the sheet metal 71-2. The optical housing H has an opening of a required size such that the frame sheet metal 70 can move after the ear portion 70b of the frame sheet metal 70 is inserted in the opening S2 of the sheet metal 71-2. A leaf spring 72-2 is screwed to the sheet metal 71-2 by a screw 73-3. As shown in FIG. 5B, the leaf spring 72-2 comes into contact with the ear portion 70b of the sheet metal 70. The individual lens 37-2Y is pressed, against a projection R of the sheet metal 71-2 via the leaf spring 72-2 and fixed to the sheet metal 71-2. Therefore, when the sheet metal 71-2 is moved in parallel to the alternate long and two short dashes line 74a by a predetermined distance, the individual lens 37-2Y fixed to the sheet metal 71-2 also moves in the direction parallel to the alternate long and two short dashes line 74a by a moving distance same as a moving distance of the sheet metal 71-2 according to the movement of the sheet metal 71-2. After a focus position in the sub-scanning direction is adjusted, the sheet metal 71-1 is screwed to the optical housing H by a screw 73-2. The sheet metal 71-2 is screwed to the optical housing H by a screw 73-4.

When defocus in the sub-scanning direction concerning the optical elements included in the post-deflection optical system 37 is corrected, first, after the cylinder lens 54 (the lens having positive power only in the sub-scanning direction) of the pre-deflection optical system 39 is moved in the optical axis direction to adjust a focus in the sub-scanning direction of the beam LK, the pre-deflection optical system 39 including the cylinder lens 54 is bonded to the optical housing of the optical beam scanning apparatus 3 and fixed. Subsequently, the individual lenses 37-2Y, 37-2M, and 37-2C are moved in parallel to the alternate long and two short dashes line 74a shown in FIGS. 5A and 5B. This makes it possible to slide the individual lenses 37-2Y, 37-2M, and 37-2C in the direction parallel to the incident optical path and adjust focuses in the sub-scanning direction of the beams LY, LM, and LC. Consequently, the image forming apparatus 1 according to this embodiment can suitably adjust the optical elements included in the scanning optical system in which the individual focusing lenses (the individual lenses 37-2) are provided for the respective color components.

The image forming apparatus 1 according to this embodiment adjusts the focus position in the sub-scanning direction of the beam LK (the beam for black) using the cylinder lens 54 of the pre-deflection optical system 39, which is the optical element having positive power only in the sub-scanning direction. The image forming apparatus 1 adjusts the focus positions in the sub-scanning direction of the beam LY (the beam for yellow), the beam LM (the beam for magenta), and the beam LC (the beam for cyan) using the position adjusting mechanism 69 that adjusts the positions of the individual lenses 37-2. However, the adjustment of the focus positions is not limited to this. When defocus in the sub-scanning direction occurs concerning the optical elements included in the optical beam scanning system because of an error during manufacturing of the housing, the image forming apparatus 1 according to this embodiment may fix the cylinder lens 54 of the pre-deflection optical system 39 without an adjusting mechanism for adjusting the cylinder lens 54, which is the optical element having positive power only in the sub-scanning direction, and adjust the focus positions in the sub-scanning direction of the beam LY (the beam for yellow), the beam LM (the beam for magenta), the beam LC (the beam for cyan), and the beam LK (the beam for black) using the position adjusting mechanism 69 for adjusting four individual lens 37-2 of four color components including black color, the position adjusting mechanism 69 adjusting the positions of the individual lenses 37-2 as shown in FIGS. 5A and 5B.

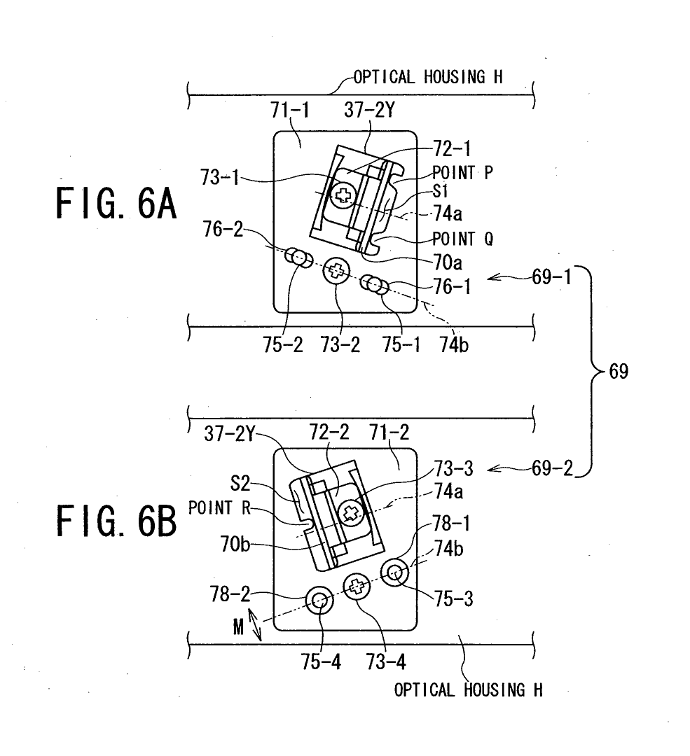

Even if an optical characteristic in the scanning optical system of the optical beam scanning apparatus 3 can be substantially perfectly set, scanning lines on the photoconductive drums 23 for the respective color components could tilt with respect to the photoconductive drums 23 depending on a way of attaching the photoconductive drums 23. The tilt of the scanning lines could be different for each of the color components. The tilt of the scanning lines due to the way of attaching the photoconductive drums 23 could occur irrespective of whether the individual lenses 37-2 are formed by using the same cavity or formed by using at least two kinds of cavities. Therefore, as shown in FIGS. 6A and 6B, the individual lenses 37-2 are allowed to move in the sub-scanning direction.

FIGS. 6A and 6B are diagrams of another position adjusting mechanism 69 for adjusting the position of, for example, the individual lens 37-2Y among the individual lenses 37-2Y, 37-2M, 37-2C, and 37-2K. FIG. 6A is a side view of the position adjusting mechanism 69-1 provided on one end side of the individual lens 37-2Y. FIG. 6B is a side view of the position adjusting mechanism 69-2 provide on the other side end of the individual lens 37-2. The pair of the position adjusting mechanism 69-1 and the position adjusting mechanism 69-2 forms the position adjusting mechanism 69. Since FIG. 6A is basically the same as FIG. 5A, explanation of FIG. 6A is omitted to avoid repetition.

As shown in FIG. 6B, the optical housing H of the optical beam scanning apparatus 3 has, on the other surface on the outer side of the optical housing H of the optical beam scanning apparatus 3, two projections 75-3 and 75-4 used for adjusting the position of the individual lens 37-2Y. The two projections 75-3 and 75-4 are inserted into clearance holes 78-1 and 78-2 of the sheet metal 71-2 provided on the outer side of the optical housing H. The two projections 75-3 and 75-4 of the optical housing H of the optical beam scanning apparatus 3 are provided on the alternate long and two short dashes line 74b parallel to the alternate long and two short dashes line 74a. Consequently, in the position adjusting mechanism 69-2 shown in FIG. 6B, as in the position adjusting mechanism 69-1 shown in FIG. 6A, the sheet metal 71-2 can move in parallel to the alternate long and two short dashes line 74a. A hole diameter of the clearance holes 78-1 and 78-2 is larger than the diameter of the projections 75-3 and 75-4. Consequently, the position adjusting mechanism 69-2 shown in FIG. 6B can move the sheet metal 71-2 in the sub-scanning direction, adjust the tilt of the scanning lines in the optical beam scanning system corresponding to the individual lens 37-2Y while keeping a lens angle around the main scanning direction, and suppress color drift.

The sheet metal 71-2 has the opening S2 on the right portion of the sheet metal 71-2. The ear portion 70b of the sheet metal 70 is inserted into the opening S2 of the sheet metal 71-2. The optical housing H has an opening of a required size such that the frame sheet metal 70 can move after the ear portion 70b of the frame sheet metal 70 is inserted in the opening S2 of the sheet metal 71-2. The leaf spring 72-2 is screwed to the sheet metal 71-2 by the screw 73-3. As shown in FIG. 5B, the leaf spring 72-2 comes into contact with the ear portion 70b of the sheet metal 70. The individual lens 37-2Y is pressed against the projection R of the sheet metal 71-2 via the leaf spring 72-2 and fixed to the sheet metal 71-2. Therefore, when the sheet metal 71-2 is moved in parallel to the alternate long and two short dashes line 74a by a predetermined distance, the individual lens 37-2Y fixed to the sheet metal 71-2 also moves in the direction parallel to the alternate long and two short dashes line 74a by a moving distance same as a moving distance of the sheet metal 71-2 according to the movement of the sheet metal 71-2. When the sheet metal 71-2 is moved in the sub-scanning direction by a predetermined distance, the individual lens 37-2Y fixed to the sheet metal 71-2 also moves in the sub-scanning direction by a moving distance same as the moving distance of the sheet metal 71-2 according to the movement of the sheet metal 71-2. After a focus position in the sub-scanning direction and the tilt of the scanning lines are adjusted, the sheet metal 71-1 is screwed to the optical housing H by a screw 73-2. The sheet metal 71-2 is screwed to the optical housing H by a screw 73-4.

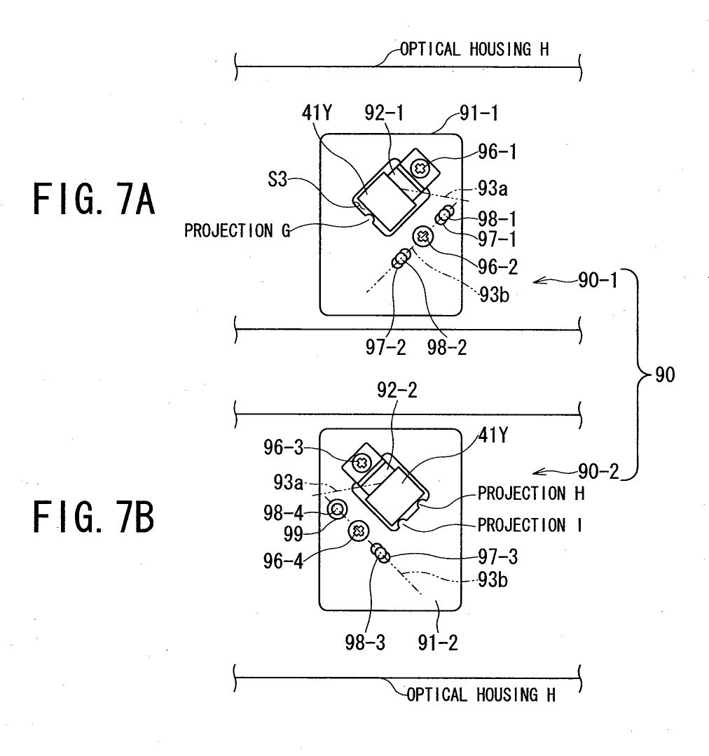

The image forming apparatus 1 according to this embodiment may adjust the tilt of the scanning lines using the folding mirrors 41 (41Y, 41M, 41C, and 41K). FIGS. 7A and 7B are diagrams of a position adjusting mechanism 90 for adjusting the position of, for example, the folding mirror 41Y among the folding mirrors 41Y, 41M, 41C, and 41K. FIG. 7A is a side view of a position adjusting mechanism 90-1 provided on one end side of the folding mirror 41Y. FIG. 7B is a side view of a position adjusting mechanism 90-2 provided on the other end side of the folding mirror 41Y. The pair of the position adjusting mechanism 90-1 and the position adjusting mechanism 90-2 forms the position adjusting mechanism 90. An alternate long and two short dashes line 93a shown in FIG. 7A is an incident optical path for the beam LY. The optical housing H of the optical beam scanning apparatus 3 has, on one side on the outer side of the optical housing H of the optical beam scanning apparatus 3, two projections 98-1 and 98-2 used for adjusting the position of the folding mirror 41Y. The two projections 98-1 and 98-2 are inserted into elongated holes 97-1 and 97-2 of a sheet metal 91-1 provided on the outer side of the optical housing H. The two projections 98-1 and 98-2 of the optical housing H of the optical beam scanning apparatus 3 are provided on an alternate long and two short dashes line 93b indicating a direction perpendicular to an incident surface of the folding mirror 41Y on which the beam LY is made incident. Consequently, in the position adjusting mechanism 90-1 shown in FIG. 7A, the sheet metal 91-1 can move in parallel to the alternate long and two short dashes line 93b. The sheet metal 91-1 has an opening S3 in the center of the sheet metal 91-1.

The folding mirror 41Y is inserted into the opening S3 of the sheet metal 91-1. The optical housing H has an opening of a required size such that the folding mirror 41Y can move after the folding mirror 41Y is inserted in the opening S3 of the sheet metal 91-1. A leaf spring 92-1 is screwed to the sheet metal 91-1 by a screw 96-1. As shown in FIG. 7A, the leaf spring 92-1 comes into contact with the folding mirror 41Y. The folding mirror 41Y is pressed against a projection G of the sheet metal 91-1 via the leaf spring 92-1 and fixed to the sheet metal 91-1. Therefore, when the sheet metal 91-1 is moved in parallel to the alternate long and two short dashes line 93b by a predetermined distance, the folding mirror 41Y fixed to the sheet metal 91-1 also moves in a direction parallel to the alternate long and two short dashes line 93b by a moving distance same as a moving distance of the sheet metal 91-1 according to the movement of the sheet metal 91-1.

On the other hand, as shown in FIG. 7B, the optical housing H of the optical beam scanning apparatus 3 has, on the other surface on the outer side of the optical housing H of the optical beam scanning apparatus 3, two projections 98-3 and 98-4 used for adjusting the position of the folding mirror 41Y. The two projections 98-3 and 98-4 are inserted into a long hole 97-3 and a round hole 99 of sheet metal 91-2 provided on the outer side of the optical housing H. A hole diameter of the round hole 99 is substantially the same as the diameter of the projection 98-4. The two projections 98-3 and 98-4 of the optical housing H of the optical beam scanning apparatus 3 are provided on the alternate long and two short dashes line 93b indicating a direction perpendicular to the incident surface of the folding mirror 41Y on which the beam LY is made incident. Consequently, in the position adjusting mechanism 90-2 shown in FIG. 7B, the sheet metal 91-2 is nearly fixed. The sheet metal 91-2 has an opening S4 in the center of the sheet metal 91-2.

The folding mirror 41Y is inserted into the opening S4 of the sheet metal 91-2. The optical housing H has an opening of a required size such that the folding mirror 41Y can move after the folding mirror 41Y is inserted in the opening S4 of the sheet metal 91-2. A leaf spring 92-2 is screwed to the sheet metal 91-2 by a screw 96-3. As shown in FIG. 7B, the leaf spring 92-2 comes into contact with the folding mirror 41Y. The folding mirror 41Y is pressed against a projection H and a projection I of the sheet metal 91-2 via the leaf spring 92-2 and fixed to the sheet metal 91-2.

As explained above, when the sheet metal 91-1 is moved in parallel to the alternate long and two short dashes line 93b by the predetermined distance, the folding mirror 41Y fixed to the sheet metal 91-1 also moves in the direction parallel to the alternate long and two short dashes line 93b by a moving distance same as a moving distance of the sheet metal 91-1 according to the movement of the sheet metal 91-1. On the other hand, since the sheet metal 91-2 is nearly fixed, the incident surface of the folding mirror 41Y tilts according to the moving distance of the sheet metal 91-1 with respect to an incident direction. Consequently, the position adjusting mechanism 90 shown in FIGS. 7A and 7B can move the folding mirror 41Y in the sub-scanning direction, adjust the tilt of the scanning lines in the optical beam scanning system corresponding to the folding mirror 41Y while keeping a lens angle around the main scanning direction, and suppress color drift. After the tilt of the scanning lines is adjusted, the sheet metal 91-1 is screwed to the optical housing H by a screw 96-2 and the sheet metal 91-2 is screwed to the optical housing H by a screw 96-4.

The configurations in this embodiment may be combined as appropriate. Specifically, the position adjusting mechanism for adjustment of the focus position in the sub-scanning direction and the position adjusting mechanism for adjusting the tilt of the scanning lines can be combined as appropriate.

The optical beam scanning system shown in FIG. 2 to FIG. 4 is an optical beam scanning system which has plural light sources 33 and plural pre-deflection optical systems 39. This optical beam scanning system shown in FIG. 2 to FIG. 4 has a same number of pre-deflection optical systems 39 as a number of scanning lines. Further, in this optical beam scanning system shown in FIG. 2 to FIG. 4, the reflection surfaces (polygon mirror surfaces) of the deflecting device 35 have the same angle with respect to the rotation center axis of the polygonal mirror main body.

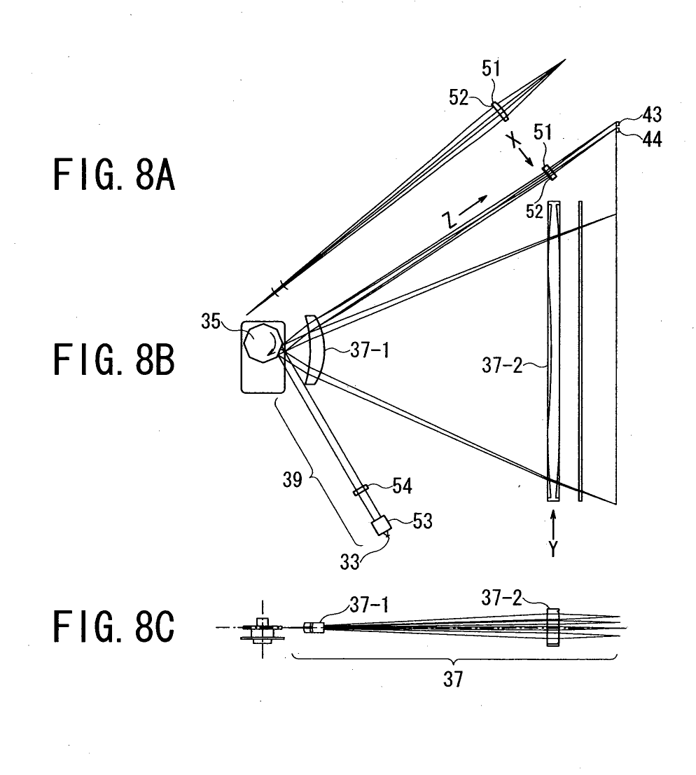

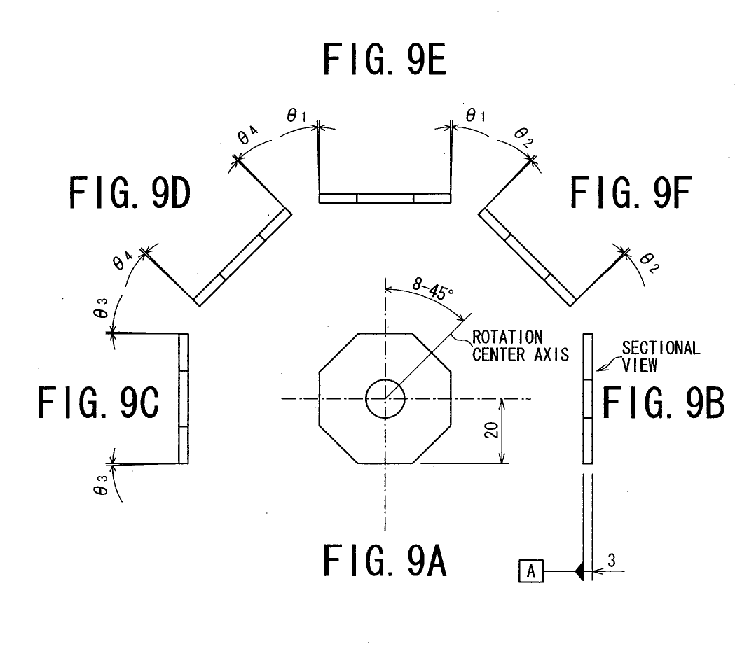

However, the optical beam scanning system applicable to the embodiment is not limited to the optical beam scanning system shown in FIG. 2 to FIG. 4. As shown in FIG. 8 and FIG. 9, the optical beam scanning system may be an optical beam scanning system which has one light source 33 and one pre-deflection optical system 39. In this case, the reflection surfaces (polygon mirror surfaces) of the deflecting device 35 respectively have required angles with respect to the rotation center axis of the polygonal mirror main body such that the reflection surfaces can guide beams to scanning line positions where electrostatic latent images are formed on the photoconductive drums 23.

FIGS. 8A to 8C are diagrams showing expansion of folding by the folding mirror provided in the optical beam scanning apparatus 3. FIG. 8A is a diagram which views FIG. 8B from an arrow X direction. FIG. 8C is a diagram which views FIG. 8B from an arrow Y direction. The reflection surfaces (polygon mirror surfaces) of the deflecting device 35 respectively have required angles with respect to the rotation center axis of the polygonal mirror main body such that the reflection surfaces can guide beams to scanning line positions where electrostatic latent images are formed on the photoconductive drums 23.

The scanning optical system of the optical beam scanning apparatus 3 includes a surface discrimination sensor 43 that outputs a signal only when the beam LK of BK (black) is scanned on the polygon mirror surface and a horizontal synchronizing sensor 44 for determining timing for drawing an image in the main scanning direction. A beam made incident on the horizontal synchronizing sensor 44 passes through the shared lens 37-1 and, then, passes through an optical element 51. The optical element 51 focuses beams passing through the different optical paths on the horizontal synchronizing sensor 44 in the sub-scanning direction while setting heights in the sub-scanning direction of all the optical paths substantially identical on the surface of the horizontal synchronizing sensor 44. The optical element 51 is a convex cylindrical lens on a surface on one side (a surface on the downstream side of the optical paths) thereof in this embodiment. A light blocking plate 52 is arranged on the upstream side of the optical path of the optical element 51. The light blocking plate 52 has a shape for blocking the optical path of the beams LY, LM, and LC to the surface discrimination sensor 43 arranged on the downstream side of the optical paths with respect to the optical element 51. The light blocking plate 52 causes only the beam LK to pass through the surface discrimination sensor 43 via the optical element 51.

On the other hand, the light blocking plate 52 causes all the beams LY, LM, LC, and LK to pass through, via the optical element 51, the horizontal synchronizing sensor 44 arranged on the downstream side of the optical paths with respect to the optical element 51. This makes it possible to suitably adjust, while discriminating the black laser beam among the laser beams of the respective colors guided from the deflecting device 35 via the optical element 51, phases of the laser beams of the respective colors for each of the laser beams. Further, it is possible to prevent occurrence of color drift even in a situation in which there is an error in accuracy of an angle of the deflection surface of the deflecting device 35 and in which an error is likely to occur in rotating speed of the deflecting device 35. Moreover, it is possible to prevent occurrence of distortion in an image of a single color.

FIGS. 9A to 9F are a plan view, a sectional view, and side view of the polygon mirror main body of the deflecting device 35 used in the scanning optical system of the optical beam scanning apparatus 3. FIG. 9A is a plan view of the polygon mirror main body of the deflecting device 35. FIG. 9B is a sectional view of the polygon mirror main body of the deflecting device 35. FIGS. 9C to 9F are sides views of the polygon mirror main body of the deflecting device 35 viewed from a predetermined direction.

The sectional view of the polygon mirror main body of the deflecting device 35 shown in FIG. 9B shows a reference surface in setting a tilt of the reflection surfaces of the polygon mirror main body. A motor is provided on an A side of the reference surface via a not-shown shaft. As shown in FIGS. 9C to 9F, the reflection surfaces of the polygon mirror main body (the polygon mirror) have required tilts with respect to the rotation center axis (a rotation center axis of the motor, in other words, a hole center axis of the polygon mirror main body). Absolute values of the tilts of the reflection surfaces are maximum and equal at θ₁ and θ₃ and signs of the tilts are set opposite. The tilts have a relation of θ₁=−θ₃ and have a relation of θ₁>θ₂>θ₄>θ₃ or θ₁<θ₂<θ₄<θ₃. For example, when a value of θ is a minus numerical value, this means that the reflection surface tilts in a direction closer to a rotation axis direction as the reflection surface is further away from the reference surface A. When a value of θ is a plus numerical value, this means that the reflection surface tilts in the direction closer to the rotation axis direction as the reflection surface is further away from a surface on the opposite side of the reference surface A.

What is claimed is:

1. An optical beam scanning apparatus comprising:
one or plural light sources configured to emit one or plural light beams;
a pre-deflection optical system configured to include a first optical element having positive optical power in a sub-scanning direction, which acts on all the light beam or all the light beams emitted from the one or plural light sources, and form the light beam or the light beams emitted from the one or plural light sources to focus the light beam or the light beams as a line image in a direction corresponding to a main scanning direction;
a light deflecting device configured to scan the light beam or the light beams focused by the pre-deflection optical system in the main scanning direction with respect to a scanning object;
a post-deflection optical system, including at least one or plural second optical elements which act on light beam or light beams of all color components and plural third optical elements which respectively act on the light beam of each of the color components, configured to focus the light beam or the light beams scanned by the light deflecting device on the scanning object; and
a position adjusting mechanism configured to adjust positions of the third optical elements according to incident directions of the light beam or the light beams made incident on the third optical elements.

2. The apparatus according to claim 1, wherein the position adjusting mechanism adjusts the positions of all the third optical elements, which act on the light beam or the light beams of the color components, along the incident directions of the light beam or the light beams made incident on the third optical elements, respectively.

3. The apparatus according to claim 1, wherein
a position of the first optical element is adjusted in an optical axis direction, and
the position adjusting mechanism adjusts, along the incident direction of the light beam or the light beams made incident on the third optical elements, positions of the third optical elements of optical paths other than an optical path in which a focus position in the sub-scanning direction is adjusted by adjusting the position of the first optical element in the optical axis direction, among the positions of the third optical elements which act on the light beam or the light beams of the color components.

4. The apparatus according to claim 1, wherein the post-deflection optical system has a same number of folding mirrors between the respective third optical elements and the scanning object.

5. The apparatus according to claim 1, wherein the post-deflection optical system does not have a folding mirror between the respective third optical elements and the scanning object.

6. The apparatus according to claim 1, wherein the plural third optical elements are molded by a same cavity or cavities in which at least two or more different cavities are combined.

7. The apparatus according to claim 1, wherein the position adjusting mechanism adjusts the positions of the third optical elements along the incident direction in which the light beam or the light beams are made incident oh the third optical elements and adjusts the positions of the third optical elements along the sub-scanning direction.

8. An optical beam scanning apparatus comprising:
one or plural light source configured to emit one or plural light beams;
a pre-deflection optical system configured to include a first optical element having positive optical power in a sub-scanning direction, which acts on all the light beam or all the light beams emitted from the one or plural light sources, and form the light beam or the light beams emitted from the one or plural light sources to focus the light beam or the light beams as a line image in a direction corresponding to a main scanning direction;
a light deflecting device configured to scan the light beam or the light beams focused by the pre-deflection optical system in the main scanning direction with respect to a scanning object;
a post-deflection optical system, including at least one or plural second optical elements which act on light beam or light beams of all color components and plural third optical elements that respectively act on the light beam of each of the color components and are molded by the same cavity or cavities in which at least two or more different cavities are combined, configured to focus the light beam or the light beams scanned by the light deflecting device on the scanning object; and
a position adjusting mechanism configured to adjust positions of the third optical elements along the sub-scanning direction.

9. The apparatus according to claim 8, wherein the post-deflection optical system has a same number of folding mirrors between the respective third optical elements and the scanning object.

10. The apparatus according to claim 8, wherein the post-deflection optical system does not have a folding mirror between the third optical elements and the scanning object.

11. The apparatus according to claim 8, wherein the position adjusting mechanism adjusts the positions of the third optical elements along the sub-scanning direction and adjusts the positions of the third optical elements along the incident direction in which the light beam or the light beams are made incident on the third optical elements.

12. An image forming apparatus including an optical beam scanning apparatus, the optical beam scanning apparatus comprising:
one or plural light source configured to emit one or plural light beams;
a pre-deflection optical system configured to include a first optical element having positive optical power in a sub-scanning direction, which acts on all the light beam or all the light beams emitted from the one or plural light sources, and form the light beam or the light beams emitted from the one or plural light sources to focus the light beam or the light beams as a line image in a direction corresponding to a main scanning direction;
a light deflecting device configured to scan the light beam or the light beams focused by the pre-deflection optical system in the main scanning direction with respect to a scanning object;
a post-deflection optical system, including at least one or plural second optical elements which act on light beam or light beams of all color components and plural third optical elements which respectively act on the light beam of each of the color components, configured to focus the light beam or the light beams scanned by the light deflecting device on the scanning object; and
a position adjusting mechanism configured to adjust positions of the third optical elements according to incident directions of the light beam or the light beams made incident on the third optical elements.

13. The apparatus according to claim 12, wherein the position adjusting mechanism adjusts the positions of all the third optical elements, which act on the light beam or the light beams of the color components, along the incident directions of the light beam or the light beams made incident on the third optical elements, respectively.

14. The apparatus according to claim 12, wherein
a position of the first optical element is adjusted in an optical axis direction, and
the position adjusting mechanism adjusts, along the incident direction of the light beam or the light beams made incident on the third optical elements, positions of the third optical elements of optical paths other than an optical path in which a focus position in the sub-scanning direction is adjusted by adjusting the position of the first optical element in the optical axis direction, among the positions of the third optical elements which act on the light beam or the light beams of the color components.

15. The apparatus according to claim 12, wherein the post-deflection optical system has a same number of folding mirrors between the respective third optical elements and the scanning object.

16. The apparatus according to claim 12, wherein the post-deflection optical system does not have a folding mirror between the third optical elements and the scanning object.

17. The apparatus according to claim 12, wherein the plural third optical elements are molded by a same cavity or cavities in which at least two different cavities are combined.

18. The apparatus according to claim 12, wherein the position adjusting mechanism adjusts the positions of the third optical elements along the incident direction in which the light beams are made incident on the third optical elements and adjusts the positions of the third optical elements along the sub-scanning direction.

19. An image forming apparatus including an optical beam scanning apparatus, the optical beam scanning apparatus comprising:
one or plural light source configured to emit one or plural light beams;
a pre-deflection optical system configured to include a first optical element having positive optical power in a sub-scanning direction, which acts on all the light beam or all the light beams emitted from the one or plural light sources, and form the light beam or the light beams emitted from the one or plural light sources to focus the light beam or the light beams as a line image in a direction corresponding to a main scanning direction;
a light deflecting device configured to scan the light beam or the light beams focused by the pre-deflection optical system in the main scanning direction with respect to a scanning object;
a post-deflection optical system, including at least one or plural second optical elements which act on light beam or light beams of all color components and plural third optical elements that respectively act on the light beam of each of the color components and are molded by the same cavity or cavities in which at least two or more different cavities are combined, configured to focus the light beam or the light beams scanned by the light deflecting device on the scanning object; and
a position adjusting mechanism configured to adjust positions of the third optical elements along the sub-scanning direction.

20. The apparatus according to claim 19, wherein the post-deflection optical system has a same number of folding mirrors between the respective third optical elements and the scanning object.

21. The apparatus according to claim 19, wherein the post-deflection optical system does not have a folding mirror between the respective third optical elements and the scanning object.

22. The apparatus according to claim 19, wherein the position adjusting mechanism adjusts the positions of the third optical elements along the sub-scanning direction and adjusts the positions of the third optical elements along the incident direction in which the light beam or the light beams are made incident on the third optical elements.

23. An optical beam scanning apparatus comprising:
one or plural light source configured to emit one or plural light beams;
a pre-deflection optical system configured to include a first optical element having positive optical power in a sub-scanning direction, which acts on all the light beam or all the light beams emitted from the one or plural light sources, and form the light beam or the light beams emitted from the one or plural light sources to focus the light beam or the light beams as a line image in a direction corresponding to a main scanning direction;
a light deflecting device configured to scan the light beam or the light beams focused by the pre-deflection optical system in the main scanning direction with respect to a scanning object;
a post-deflection optical system, including at least one or plural second optical elements which act on light beam or light beams of all color components and plural third optical elements that respectively act on the light beam of each of the color components and are molded by the same cavity or cavities in which at least two or more different cavities are combined, configured to focus the light beam or the light beams scanned by the light deflecting device on the scanning object, the post-deflection optical system having a same number of folding mirrors between the respective third optical elements and the scanning object or having no folding mirror between the third optical elements and the scanning object.
